(19) United States
(12) Patent Application Publication
(10) Pub. No.: US 2012/0253722 A1
(43) Pub. Date: Oct. 4, 2012

(54) ELECTRONIC DEVICE AND METHOD FOR MEASUREMENT OF FLATNESS OF OBJECTS USING THE ELECTRONIC DEVICE

(75) Inventors: CHIH-KUANG CHANG, Tu-Cheng (TW); ZHONG-KUI YUAN, Shenzhen City (CN); LI JIANG, Shenzhen City (CN); XIAO-GUANG XUE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/314,185

(22) Filed: Dec. 8, 2011

(30) Foreign Application Priority Data
Mar. 30, 2011 (CN) 201110078574.7

(51) Int. Cl. G01B 11/24; G06F 19/00

(52) U.S. Cl. 702/82; 702/81

(57) ABSTRACT

In a method for measurement of flatness of objects on a measuring machine, at least two objects are fixed on a worktable of the measuring machine. The method establishes a first coordinate system for the worktable location, sets two groups of horizontal scanning points for each object, and sets two groups of vertical scanning points for each object. By controlling at least two laser heads of the measuring machine, the objects are measured and coordinate values for each of the points scanned are obtained. The method calibrates a first coordinate system and establishes a second coordinate system based on the first coordinate system. In the second coordinate system, the at least two laser heads measure the objects and obtain data, and an indication of the flatness of each object is calculated and displayed on a display device.

### BACKGROUND

1. Technical Field

Embodiments of the present disclosure generally relate to object measurement methods, and more particularly to a method for measurement of flatness of objects using an electronic device thereof.

2. Description of Related Art

A measuring machine is used in the industry to measure manufactured parts. The measuring of the manufactured part can determine if the manufactured part meets design specifications and can provide information for improvements in process control. For example, the measuring machine can measure a flatness of the manufactured part. In common methods, the flatness of workpieces are measured one by one. This method requires lengthy application time, and the accuracy of the measurement may not be total. Therefore, an improved s method is desirable to address the aforementioned issues.

### BRIEF DESCRIPTION OF THE DRAWINGS

FIG. 1 is a block diagram of one embodiment of an electronic device including a flatness management unit.

FIG. 2 is a block diagram of function modules of the flatness management unit in FIG. 1.

FIG. 3 illustrates an example of setting groups of scanning points.

FIG. 4 is a flowchart illustrating one embodiment of a method for measurement of flatness of objects using the electronic device of FIG. 1.

### DETAILED DESCRIPTION

In general, the term “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or computer storage device.

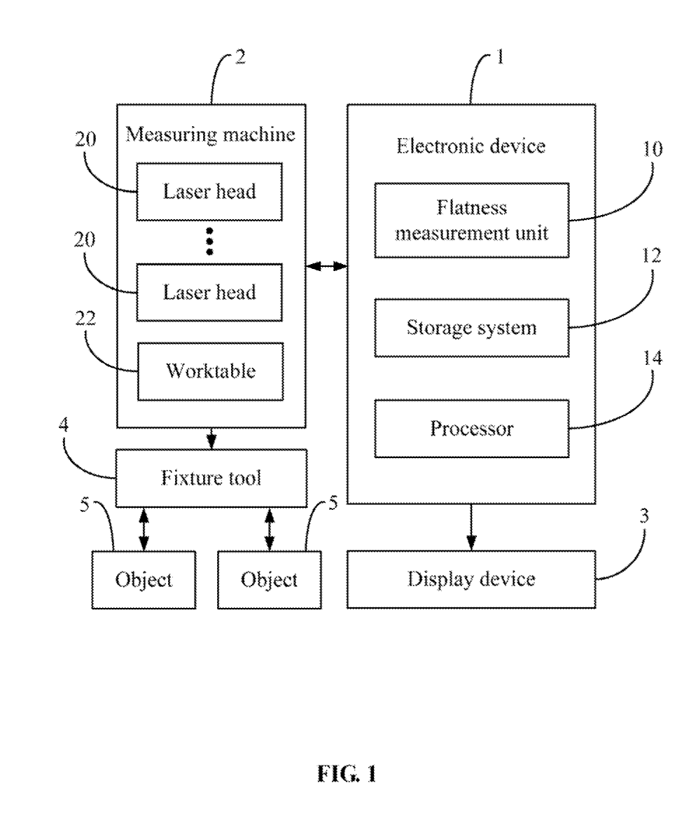

FIG. 1 is a block diagram of one embodiment of an electronic device 1 including a flatness management unit 10. In the embodiment, functions of the flatness management unit 10 are implemented by the electronic device 1. The electronic device 1 is electronically connected to a measuring machine 2 that has a worktable 22. In the embodiment, the measuring machine 2 includes at least two laser heads 20 (only two are shown in FIG. 1). The flatness management unit 10 controls the at least two laser heads 20 to simultaneously measure objects 5 on the worktable 22, and determines whether each of the objects 5 meets quality control standards. That is, the flatness management unit 10 can measure the flatness of more than one object 5 at the same time. Flatness is an important quality in objects 5 such as workpieces or tools. In order to simultaneously measure more than one object 5, a tool (fixture tool 4) can be used to hold each of the objects 5. In one embodiment, the fixture tool 4 may be a clamp.

In one embodiment, the electronic device 1 may be a computer, a server, a portable electronic device, or any other electronic device that includes a storage system 12, and at least one processor 14. In one embodiment, the storage system 12 may be a magnetic or an optical storage system, such as a hard disk drive, an optical drive, a compact disc, a digital video disc, a tape drive, or other suitable storage medium. The processor 14 may be a central processing unit including a math co-processor, for example.

The electronic device 1 is electronically connected to a display device 3. The display device 3 is configured for indicating the flatness of each object 5, and reporting information as to quality control.

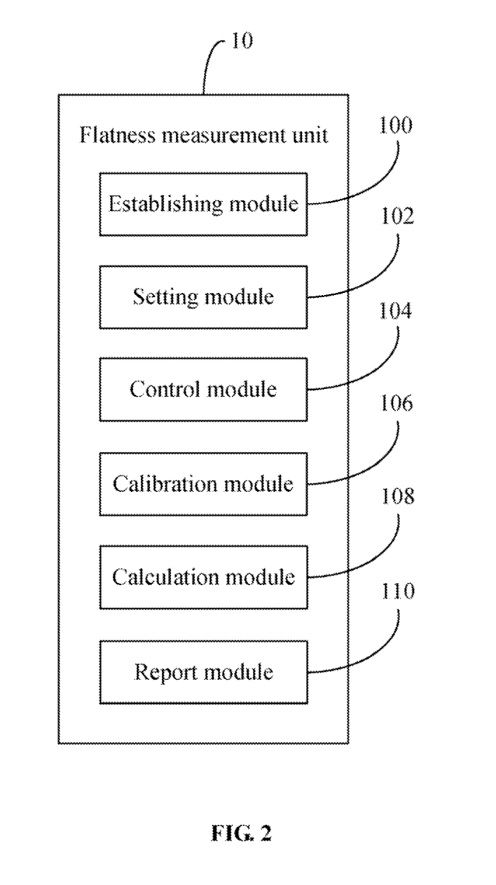

FIG. 2 is a block diagram of function modules of the flatness measurement unit 10 in FIG. 1. In one embodiment, the flatness measurement unit 10 includes an establishing module 100, a setting module 102, a control module 104, a calibration module 106, a calculation module 108, and a report module 110. Each of the modules 100-110 may be a software program including one or more computerized instructions that are stored in the storage system 12 and executed by the processor 14.

The establishing module 100 establishes a first coordinate system for the worktable 22 of the measuring machine 2. In the embodiment, two objects 5 can be held by the fixture tool 4 where the fixture tool 4 is positioned on a surface of the worktable 22 of the measuring machine 2. The measuring machine 2 has two laser heads 20, and each of the two laser heads 20 is vertically above one object 5. For example, if two objects “a” and “b” are held down by the fixture tool 4 which is sitting on the worktable 22, and the measuring machine 2 has two laser heads “c” and “d,” the laser head “c” is just above the object “a,” and the laser head “d” is just above the object “b.” The laser head “c” is used for scanning the measuring points of the object “a,” and the laser head “d” is used for scanning the measuring points of the object “b.”

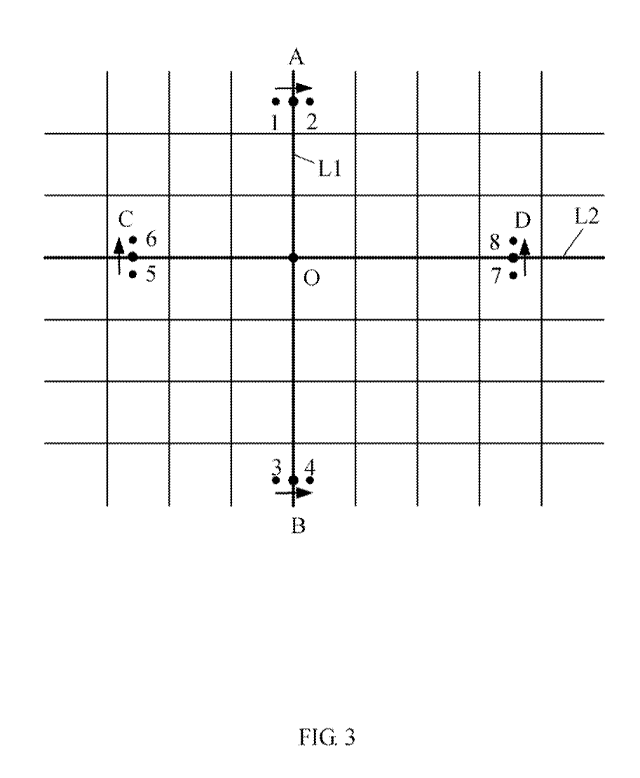

The setting module 112 sets two groups of horizontal scanning points for each of the objects 5, and sets two groups of vertical scanning points for each of the objects 5. Each of the groups of scanning points includes a start scanning point and an end scanning point. As shown in FIG. 3, the groups “A” and “B” are two groups of vertical scanning points for one object 5, and the groups “C” and “D” are two groups of horizontal scanning points for the object 5. The group “A” has a start scanning point “1” and an end scanning point “2,” the group “B” has a start scanning point “3” and an end scanning point “4,” the group “C” has a start scanning point “5” and an end scanning point “6,” and the group “D” has a start scanning point “7” and an end scanning point “8.”

The control module 104 controls the two laser heads 20 to measure the objects 5 by scanning the groups of scanning points on the objects 5, and obtains coordinate values for each of the groups of scanning points for a first coordinate system. In detail, the control module 104 controls the two laser heads 20 to scan each of the groups of scanning points from the start scanning point to the end scanning point of each of the scanning points. The coordinate values of each of the objects 5 include an x-axis value, a y-axis value, and a z-axis value.

The calibration module 106 calibrates the first coordinate system and establishes a second coordinate system based on the coordinate values.

In detail, the calibration module 106 determines whether one of the laser heads 20 has scanned a point by detecting whether the z-axis value is a null value, means that detecting whether the z-axis value is zero. For example, the object 5 may be a computer keyboard, and the laser head 20 needs to measure the keys in the keyboard. If the z-axis value is not a null value, the calibration module 106 can determine that the laser head 20 has scanned at least one key of the keyboard. If the z-axis value shows a null value, the calibration module 106 can determine that the laser head 20 has scanned a gap between two keys of the keyboard. Following this method, the calibration module 106 can detect all the points scanned by the laser head 20 in each group of scanning points of the object 5. Next, the calibration module 106 finds as the first scanning point and the last scanning point the first and last points where the z-axis values do not have a null value in each group of scanning points. The calibration module 106 calculates a midpoint of the first and last scanning points in each group of scanning points, connects each of the calculated midpoints in the horizontal direction to obtain a horizontal line, and connects each of the midpoints in the vertical direction to obtain a vertical line. Each of the horizontal lines and the vertical lines have an intersection point. The calibration module 106 establishes the second coordinate system by taking each intersection point as an origin, by regarding the horizontal line as the x-axis, and by regarding the vertical line as the y-axis of the second coordinate system.

As shown in FIG. 3, if all the points in each group of scanning points have been scanned by the laser head 20, the calibration module 106 connects the midpoint of the group “A” with the midpoint of the group “B” to obtain a straight line “L1,” the calibration module 106 connects the midpoint of the group “C” with the midpoint of the group “D” to obtain a straight line “L2,” where the straight lines “L1” and “L2” have an intersection point “O.” The intersection point “O” is the origin of the second coordinate system, the straight line “L2” is the x-axis of the second coordinate system, and the straight line “L1” is the y-axis of the second coordinate system.

The control module 104 further controls the two laser heads 20 to measure the objects 5 by reference to the second coordinate system, and obtains measurement data of the objects 5.

The calculation module 108 calculates a flatness of each of the objects 5 based on measurements taken according to the second coordinate system. Supposing there are N scanning points Pᵢ (xᵢ, yᵢ, zᵢ), where i=1, 2, . . . , N, on a surface of the object 5, and an equation of the surface is: z=Ax+By +C, and an objective function of the plane is

$$F ( A , B , C ) = {\sum }_{i = 1}^{N} {( {Ax}_{i } + {By}_{i} + C - {Z}_{i } )}^{2} .$$

According to an extremum principle, if a user wants to obtain a minimum value of the objective function F (A, B, C),

$$\frac{\partial F}{\partial A} = 0 , \frac{\partial F}{\partial B} = 0 , \frac{\partial F}{\partial C} = 0 ,$$

then:

$$\begin{matrix}A = \frac{{S}_{12} {S}_{23} - {S}_{13} {S}_{22}}{{S}_{12}^{2} - {S}_{11} {S}_{22}} \\ B = \frac{{S}_{12} {S}_{13} - {S}_{11} {S}_{23}}{{S}_{12}^{2} - {S}_{11} {S}_{22}} \\ C = \frac{{\sum }_{i = 1}^{N} {z}_{i} - A {\sum }_{i = 1}^{N} {x}_{i} - B {\sum }_{i = 1}^{N} {y}_{i}}{N}\end{matrix} \} ,$$

where:

$${S}_{11} = {\sum }_{i = 1}^{N} {x}_{i}^{2} - \frac{1}{N} {( {\sum }_{i = 1}^{N} {x}_{i} )}^{2} , \\ {S}_{12} = {\sum }_{i = 1}^{N} {x}_{i} {y}_{i} - \frac{1}{N} {\sum }_{i = 1}^{N} {x}_{i} {\sum }_{i = 1}^{N} {y}_{i} , \\ {S}_{13} = {\sum }_{i = 1}^{N} {x}_{i} {z}_{i} - \frac{1}{N} {\sum }_{i = 1}^{N} {x}_{i} {\sum }_{i = 1}^{N} {z}_{i} , \\ {S}_{22} = {\sum }_{i = 1}^{N} {y}_{i}^{2} - \frac{1}{N} {( {\sum }_{i = 1}^{N} {y}_{i} )}^{2} , \\ {S}_{23} = {\sum }_{i = 1}^{N} {y}_{i} {z}_{i} - \frac{1}{N} {\sum }_{i = 1}^{N} {y}_{i} {\sum }_{i = 1}^{N} {z}_{i} , \\ \begin{matrix}l = \frac{A}{\sqrt{{A}^{2} + {B}^{2} + 1}} \\ and m = \frac{B}{\sqrt{{A}^{2} + {B}^{2} + 1}} \\ n = \frac{- 1}{\sqrt{{A}^{2} + {B}^{2} + 1}}\end{matrix} \} ,$$

(l, m, n) is a normal vector of the surface. The flatness of the object 5 is equal to a total of a maximum distance between a point above the surface and a maximum distance between a point under the surface. The distance can be established according to the formula:

$$d = \frac{\vert Ax + By + Cz \vert}{\sqrt{{A}^{2} + {B}^{2} + {C}^{2}}} .$$

The report module 110 displays an indication of the flatness of each of the objects 5 on the display device 3. Furthermore, the report module 110 determines whether the flatness of each of the objects 5 is within a predetermined range according to the requirements of quality control. If the flatness of one of the objects 5 is within the predetermined range, the report module 110 reports that the object 5 is acceptable, and displays indication of the flatness in a first color. If the flatness of any object 5 is not within the predetermined range, the report module 110 reports that the object 5 is not acceptable, and marks the relevant indication in a different second color.

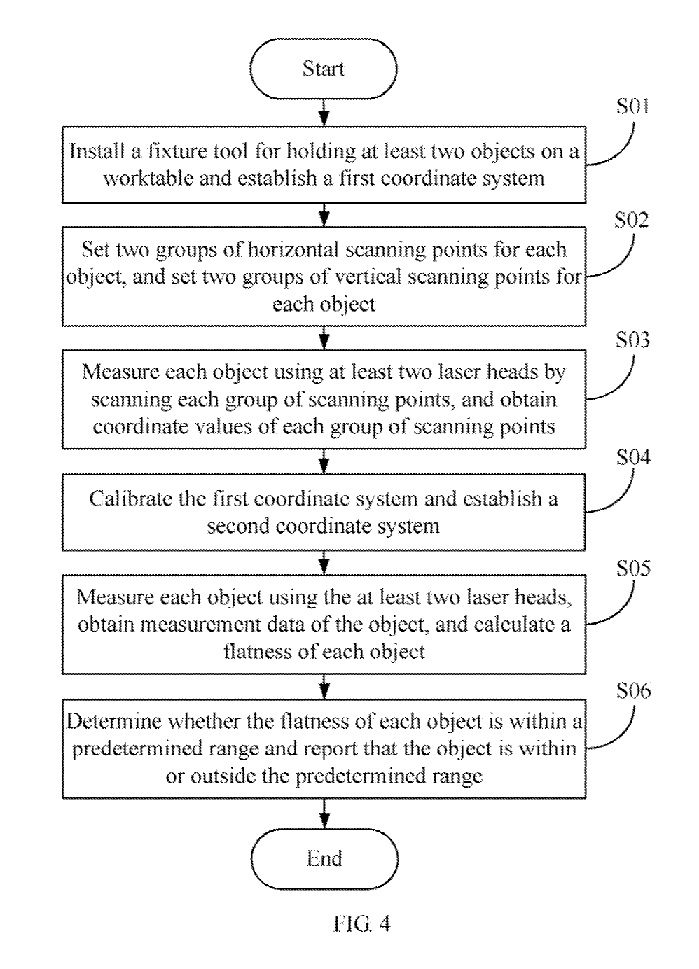

FIG. 4 is a flowchart illustrating one embodiment of a method for measurement of flatness of objects using the electronic device of FIG. 1. The method can be performed by the execution of a computer-readable program by the at least one processor 12. Depending on the embodiment, in FIG. 4, additional blocks may be added, others removed, and the ordering of the blocks may be changed.

In block S01, a fixture tool 4 for holding down more than one object 5 is installed in a worktable 22 of the measuring machine 2, and the establishing module 100 may begin to establish a first coordinate system for the worktable 22. In the embodiment, two objects 5 are held down by the fixture tool 4, and the fixture tool 4 is sitting on the worktable 22. The measuring machine 2 has two laser heads 20, and each of the two laser heads 20 is vertically above one object 5. For example, the laser head “c” is just above the object “a” for scanning the measuring points of the object “a,” and the laser head “d” is just above the object “b” for scanning the measuring points of the object “b.”

In block S02, the setting module 112 sets two groups of horizontal scanning points for each of the objects 5, and sets two groups of vertical scanning points for each of the objects 5. Each of the groups of scanning points includes a start scanning point and an end scanning point.

In block S03, the control module 104 controls the two laser heads 20 to measure the objects 5 by scanning the groups of scanning points relating to each object 5, and obtains coordinate values of each of the groups of scanning points for the first coordinate system. In detail, the control module 104 controls the two laser heads 20 to scan each of the groups of scanning points from the start scanning point to the end scanning point. The coordinate values for each of the scanning points include an x-axis value, a y-axis value, and a z-axis value.

In block S04, the calibration module 106 calibrates a first coordinate system and establishes a second coordinate system based on the coordinate values.

In block S05, the control module 104 controls the two laser heads 20 to measure the objects 5 according to a second coordinate system. The calculation module 108 calculates a flatness of each of the objects 5 according to the measurements taken in relation to the second coordinate system. The indication(s) as to the flatness of each of the objects 5 are displayed on the display device 3.

In block S06, the report module 110 determines whether the flatness of each of the objects 5 is within a certain predetermined range, and reports that the object 5 is within or outside the range. In detail, if the flatness of one object 5 is within the predetermined range, the report module 110 reports that the object 5 is acceptable, and indicates the flatness in a first color on the display screen 3. If the flatness of any object 5 is not within the predetermined range, the report module 110 reports that the object 5 is unacceptable, and indicates the flatness in a different second color on the display screen 3.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method of an electronic device in electronic communication with a measuring machine, the method comprising:
(a) establishing a first coordinate system for a worktable of the measuring machine, the worktable having at least two objects positioned thereon;
(b) setting two groups of horizontal scanning points for each of the objects, and setting two groups of vertical scanning points for each of the objects;
(c) measuring the objects using at least two laser heads of the measuring machine by scanning each of the groups of scanning points, and obtaining coordinate values of each of the groups of scanning points from the first coordinate system;
(d) calibrating the first coordinate system and establishing a second coordinate system according to the coordinate values;
(e) measuring the objects using the at least two laser heads in the second coordinate system, and obtaining measurement data of the objects; and
(f) calculating a flatness of each of the objects based on the second coordinate system and the measurement data, and displaying an indication of the flatness of each of the objects on a display device that is electronically connected to the electronic device.

2. The method as described in claim 1, wherein each of the groups of scanning points comprises a start scanning point and an end scanning point, and each of the objects is measured by scanning each of the groups of scanning points from the start scanning point to the end scanning point in the group of scanning points.

3. The method as described in claim 1, wherein the coordinate values of each of the objects comprise an x-axis value, a y-axis value, and a z-axis value.

4. The method as described in claim 3, wherein the block (d) comprises:
determining whether each of the laser heads has measured a scanning point by detecting whether the z-axis value is a null value, and finding a first scanning point of which a z-axis value is not the null value and a last scanning point of which the z-axis value is not the null value in each of the groups of scanning points;
calculating a midpoint of the first scanning point and the last scanning point in each of the groups of scanning points;
connecting midpoints in the horizontal direction to obtain a horizontal line, and connecting midpoints in the vertical direction to obtain a vertical line, the horizontal line and the vertical line having an intersection point; and
establishing the second coordinate system by regarding the intersection point as an origin, by regarding the horizontal line as an x-axis, and by regarding the vertical line as a y-axis of the second coordinate system.

5. The method as described in claim 1, further comprising:
determining whether the flatness of each of the objects is within a predetermined range.

6. The method as described in claim 5, further comprising:
reporting that the object is acceptable and indicating the flatness in a first color on the display device, upon the condition that the flatness of one of the objects is within the predetermined range; or
reporting that the object is not acceptable and indicating the flatness in a different second color on the display device, upon the condition that the flatness of any object is not within the predetermined range.

7. An electronic device, comprising:
at least one processor;
a storage system; and
one or more modules that are stored in the storage system and executed by the at least one processor, the one or more modules comprising:
an establishing module that establishes a first coordinate system for a worktable of a measuring machine that is in electronic communication with the electronic device, the worktable having at least two objects positioned thereon;
a setting module that sets two groups of horizontal scanning points for each of the objects, and set two groups of vertical scanning points for each of the objects;
a control module that measures the objects using at least two laser heads of the measuring machine by scanning each of the groups of scanning points, and obtain coordinate values of each of the groups of scanning points from the first coordinate system;
a calibration module that calibrates the first coordinate system and establish a second coordinate system according to the coordinate values;
the control module further that measures the objects using the at least two laser heads in the second coordinate system, and obtain measurement data of the objects;
a calculation module that calculates a flatness of each of the objects based on the second coordinate system and the measurement data; and
a report module that displays an indication of the flatness of each of the objects on a display device that is electronically connected to the electronic device.

8. The electronic device as described in claim 7, wherein each of the groups of scanning points comprises a start scanning point and an end scanning point, and the control module measures each of the objects by scanning each of the groups of scanning points from the start scanning point to the end scanning point in the group of scanning points.

9. The electronic device as described in claim 7, wherein the coordinate values of each of the objects comprise an x-axis value, a y-axis value, and a z-axis value.

10. The electronic device as described in claim 9, wherein the calibration module calibrates the coordinate system by:
determining whether each of the laser heads has measured a scanning point by detecting whether the z-axis value is a null value, and finding a first scanning point of which a z-axis value is not the null value and a last scanning point of which the z-axis value is not the null value in each of the groups of scanning points;
calculating a midpoint of the first scanning point and the last scanning point in each of the groups of scanning points;
connecting midpoints in the horizontal direction to obtain a horizontal line, and connecting midpoints in the vertical direction to obtain a vertical line, the horizontal line and the vertical line having an intersection point; and
establishing the second coordinate system by regarding the intersection point as an origin, by regarding the horizontal line as an x-axis, and by regarding the vertical line as a y-axis of the second coordinate system.

11. The electronic device as described in claim 7, wherein the report module further determines whether the flatness of each of the objects is within a predetermined range.

12. The electronic device as described in claim 11, wherein the report module reports that the object is acceptable and indicates the flatness in a first color on the display device, upon the condition that the flatness of one of the objects is within the predetermined range, or reports that the object is not acceptable and indicates the flatness in a different second color on the display device, upon the condition that the flatness of any object is not within the predetermined range.

13. A non-transitory storage medium having stored thereon instructions that, when executed by a processor of an electronic device, causes the electronic device to perform a method for measurement of flatness of objects, the electronic device is in electronic communication with a measuring machine, the method comprising:
(a) establishing a first coordinate system for a worktable of the measuring machine, the worktable having at least two objects positioned thereon;
(b) setting two groups of horizontal scanning points for each of the objects, and setting two groups of vertical scanning points for each of the objects;
(c) measuring the objects using at least two laser heads of the measuring machine by scanning each of the groups of scanning points, and obtaining coordinate values of each of the groups of scanning points from the first coordinate system;
(d) calibrating the first coordinate system and establishing a second coordinate system according to the coordinate values;
(e) measuring the objects using the at least two laser heads in the second coordinate system, and obtaining measurement data of the objects; and
(f) calculating a flatness of each of the objects based on the second coordinate system and the measurement data, and displaying an indication of the flatness of each of the objects on a display device that is electronically connected to the electronic device.

14. The non-transitory storage medium as described in claim 13, wherein each of the groups of scanning points comprises a start scanning point and an end scanning point, and each of the objects is measured by:
scanning each of the groups of scanning points from the start scanning point to the end scanning point in the group of scanning points.

15. The non-transitory storage medium as described in claim 13, wherein the coordinate values of each of the objects comprise an x-axis value, a y-axis value, and a z-axis value.

16. The non-transitory storage medium as described in claim 15, wherein the block (d) comprises:
determining whether each of the laser heads has measured a scanning point by detecting whether the z-axis value is a null value, and finding a first scanning point of which a z-axis value is not the null value and a last scanning point of which the z-axis value is not the null value in each of the groups of scanning points;
calculating a midpoint of the first scanning point and the last scanning point in each of the groups of scanning points;
connecting midpoints in the horizontal direction to obtain a horizontal line, and connecting midpoints in the vertical direction to obtain a vertical line, the horizontal line and the vertical line having an intersection point; and
establishing the second coordinate system by regarding the intersection point as an origin, by regarding the horizontal line as an x-axis, and by regarding the vertical line as a y-axis of the second coordinate system.

17. The non-transitory storage medium as described in claim 13, wherein the method further comprises:
determining whether the flatness of each of the objects is within a predetermined range.

18. The non-transitory storage medium as described in claim 17, wherein the method further comprises:
reporting that the object is acceptable and indicating the flatness in a first color on the display device, upon the condition that the flatness of one of the objects is within the predetermined range; or
reporting that the object is not acceptable and indicating the flatness in a different second color on the display device, upon the condition that the flatness of any object is not within the predetermined range.
